(19) United States
(12) Patent Application Publication
(10) Pub. No.: US 2026/0128894 A1
(43) Pub. Date: May 7, 2026

(54) HARDWARE-ENFORCED IDENTITY GOVERNANCE ENGINE

(71) Applicant: George William Bickerstaff, III, Greenwich, CT (US)

(72) Inventor: George William Bickerstaff, III, Greenwich, CT (US)

(21) Appl. No.: 19/437,146

(22) Filed: Dec. 30, 2025

(51) Int. Cl. H04L 9/32

(52) U.S. Cl. CPC H04L 9/3218

(57) ABSTRACT

A hardware-enforced identity governance engine maintains an identity confidence state within trusted execution environments and enforces that state as a pre-computational prerequisite to influence forecasting and trust-weighted governance. The system incorporates behavioral entropy analysis, context-aware decay, recursive refresh using zero-knowledge proofs, and temporal immutability to prevent invalid authority states. Influence forecasts and governance outputs cannot be generated unless identity validity is cryptographically confirmed.

### FIELD OF THE INVENTION

The present invention relates generally to secure digital identity systems and computational governance architectures. More particularly, the invention relates to systems and methods for maintaining an identity confidence state within hardware-isolated execution environments and enforcing that state as a hardware-locked, pre-computational prerequisite to influence forecasting, trust-weighted governance, and compliance execution in distributed computing systems.

### BACKGROUND OF THE INVENTION

Modern digital platforms increasingly allocate authority, access, and economic value using influence scores, reputation metrics, or trust-weighted voting rather than static credentials. U.S. Publication No. US-2025-0392470-A1 discloses systems for forecasting influence as a dynamic, time-varying signal derived from behavioral and network inputs. U.S. Publication No. US-2025-0391219-A1 discloses governance systems that weight decisions based on trust or influence metrics.

Existing systems typically treat identity verification as static, external, or peripheral to governance computation. As a result, influence forecasts and governance outputs may be generated using stale, compromised, automated, or invalid identities. This produces unauthorized authority states, governance instability, and regulatory exposure.

These failures arise from a technical limitation in which identity validation is not enforced as a mandatory prerequisite to computation. Without a pre-computational identity constraint, distributed systems remain vulnerable to Sybil attacks, autonomous AI agent swarms, identity drift, and compliance failures. There is therefore a need for a technical solution that enforces identity validity at the hardware level before governance computation is permitted to occur.

### SUMMARY OF THE INVENTION

The present invention provides a hardware-enforced identity governance engine. The system continuously evaluates an identity confidence state derived from heterogeneous attestations, behavioral entropy analysis, context-aware decay, and recursive validation logic. The identity confidence state is maintained as a persistent, versioned computational object within a trusted execution environment.

A hardware-locked pre-computational gate prevents the generation of influence forecasts or trust-weighted governance outputs unless identity confidence thresholds are satisfied. Influence forecasts computed according to U.S. Publication No. US-2025-0392470-A1 and trust-weighted governance outputs computed according to U.S. Publication No. US-2025-0391219-A1 are explicitly bound to this engine as mandatory computational prerequisites. This binding creates a secure, auditable, and regulator-ready governance foundation.

### DEFINITIONS

Action Intent: A contextual classification of a requested operation indicating purpose, risk level, and governance impact.

Adaptive Decay: A variable reduction of identity confidence over time based on action intent, contextual risk, or policy thresholds.

Attestation Source: Any cryptographic, biometric, institutional, device-based, or credential-based input used to establish identity validity.

Behavioral Entropy: Quantitative measures of non-deterministic behavior including interaction variance, timing irregularity, or input dynamics.

Governance Output: Any computed result affecting authority, access rights, voting weight, compliance eligibility, or influence allocation.

Hardware-Locked Pre-Computational Gate: A security barrier enforced within a trusted execution environment that prevents generation of governance outputs unless identity criteria are satisfied.

Identity Confidence State: A persistent, versioned computational object representing identity validity based on attestations, decay, recursive refresh, and policy evaluation.

Recursive Refresh: A process whereby newly validated high-confidence attestations reconcile and repair prior provisional trust states.

Temporal Immutability: A property ensuring that historical identity states remain mathematically consistent even as current identity confidence states are updated.

Trusted Execution Environment (TEE): A hardware-isolated execution environment including Intel SGX, AWS Nitro Enclaves, Apple Secure Enclave, AMD SEV, or functionally equivalent technologies.

Trust-Weighted Governance: Decision-making or voting mechanisms that allocate authority proportionally based on trust or identity confidence.

Zero-Knowledge Proof (ZKP): A cryptographic method enabling verification of identity-related claims without disclosure of underlying private data.

### DETAILED DESCRIPTION OF THE INVENTION

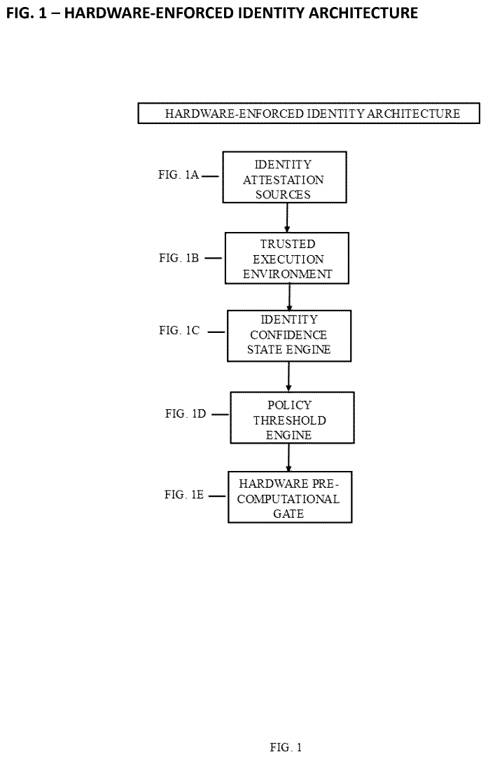

### FIG. 1—Hardware-Enforced Identity Architecture

FIG. 1 illustrates the overall system architecture of the hardware-enforced identity governance engine. Identity processing is confined to hardware-isolated execution environments to prevent tampering, inspection, or bypass of identity validation logic. Governance computation is inaccessible unless identity validation is completed successfully.

FIG. 1A illustrates heterogeneous identity attestation sources supplying identity evidence to the system. These sources include cryptographic credentials, biometric data, institutional records, and device-based proofs. Each attestation source contributes weighted evidence toward the identity confidence state.

FIG. 1B illustrates secure identity processing within a trusted execution environment. Hardware isolation prevents external modification, replay, or inspection of identity logic and data. All identity evaluation occurs exclusively within the enclave boundary.

FIG. 1C illustrates aggregation of attestation inputs into a persistent identity confidence state. The identity confidence state is versioned and cryptographically bound to the hardware execution environment. Historical states are retained to support auditability and temporal consistency.

FIG. 1D illustrates a policy threshold engine that evaluates identity confidence against defined requirements. Thresholds vary based on jurisdiction, regulation, system policy, or action intent. Eligibility for governance actions is determined prior to computation.

FIG. 1E illustrates a hardware-locked pre-computational gate. The gate prevents governance computation unless identity confidence thresholds are satisfied. The gate operates as a mandatory enforcement point within the hardware execution path.

The modules, engines, and gates described with respect to FIG. 1 may be implemented using one or more processors executing stored instructions, hardware security modules, trusted execution environments, or combinations thereof, without limitation to a specific programming language, operating system, or deployment architecture.

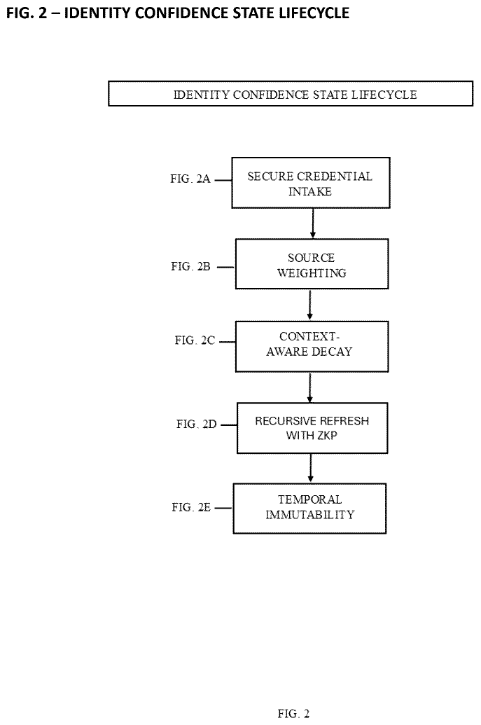

### FIG. 2—Identity Confidence State Lifecycle

FIG. 2 illustrates the lifecycle of the identity confidence state. Identity confidence evolves through validation, decay, recursive refresh, and persistence. Temporal immutability ensures historical audit integrity.

FIG. 2A illustrates secure intake of identity attestations into the trusted execution environment. Attestations are timestamped and context-tagged upon entry. Intake occurs before any governance computation is permitted.

FIG. 2B illustrates weighting of attestation sources. Weights reflect reliability, freshness, and relevance of each source. Aggregated weights update the identity confidence state.

FIG. 2C illustrates adaptive decay of identity confidence over time. Decay rates are adjusted based on action intent and risk classification. Higher-risk actions require more recent identity validation.

FIG. 2D illustrates recursive refresh using zero-knowledge proofs. Newly validated high-confidence attestations repair prior provisional trust states. Private identity data is not disclosed during refresh.

FIG. 2E illustrates preservation of temporal immutability. Historical identity states remain mathematically consistent despite updates. Audit trails remain intact and verifiable.

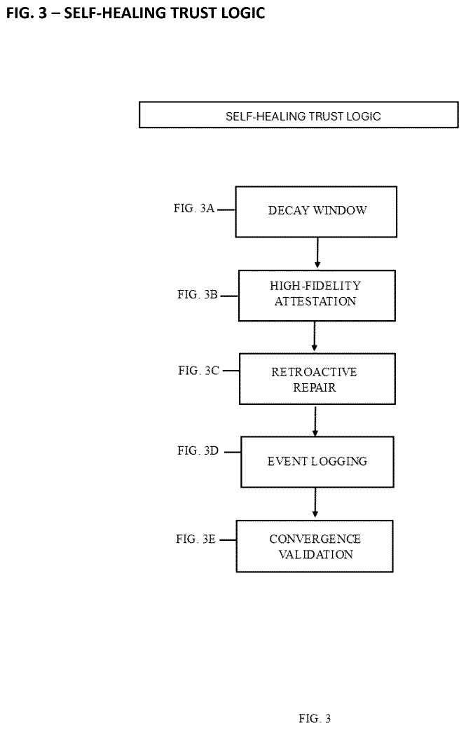

### FIG. 3—Self-Healing Trust Logic

FIG. 3 illustrates self-healing identity trust logic. Provisional trust states are reconciled as new information becomes available. System accuracy improves over time.

FIG. 3A illustrates a trust decay window. Actions within the window are provisionally trusted. Final authority is determined after validation.

FIG. 3B illustrates receipt of high-fidelity identity attestation. Examples include biometric confirmation or notarized credentials. Such attestations override decay effects.

FIG. 3C illustrates retroactive repair of trust states. Prior governance computations are reconciled accordingly. Trust accuracy is restored.

FIG. 3D illustrates immutable event logging. Before-and-after trust states are recorded. Logs support forensic and regulatory review.

FIG. 3E illustrates convergence validation. The system confirms stabilization of identity confidence. Repaired states become final.

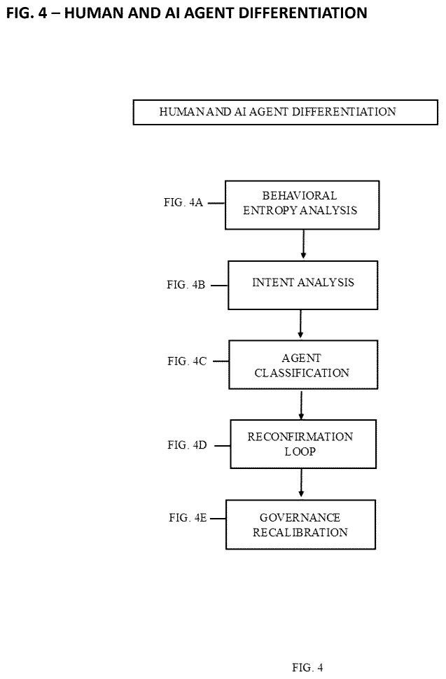

### FIG. 4—Human and AI Agent Differentiation

FIG. 4 illustrates differentiation between human users and AI agents. Behavioral entropy metrics are evaluated to classify actors. Classification influences governance authority.

FIG. 4A illustrates analysis of behavioral entropy. Metrics include timing variance, interaction randomness, and input dynamics. Human and automated behaviors are statistically distinguishable.

FIG. 4B illustrates evaluation of action intent. Intent reflects contextual risk and purpose. Identity requirements adjust accordingly.

FIG. 4C illustrates classification of actors as human, hybrid, or autonomous. Classification modifies permitted actions. Certain governance actions may be restricted.

FIG. 4D illustrates a reconfirmation loop. Ambiguous actors are re-challenged for proof. Classification is updated.

FIG. 4E illustrates recalibration of governance authority. Influence and voting weights reflect updated trust. System integrity is preserved.

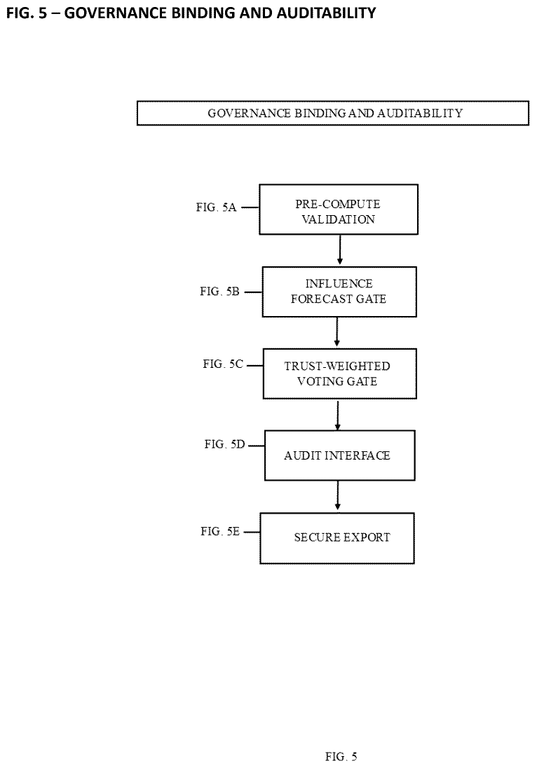

### FIG. 5—Governance Binding and Auditability

FIG. 5 illustrates governance enforcement and auditability. Identity validation is enforced prior to computation. Governance outputs are traceable.

FIG. 5A illustrates identity validation before governance computation. Invalid identities are blocked. Security enforcement is maintained.

FIG. 5B illustrates gating of influence forecasts. Forecasts per U.S. Publication No. US-2025-0392470-A1 require identity clearance. Identity is mandatory.

FIG. 5C illustrates gating of trust-weighted voting. Votes per U.S. Publication No. US-2025-0391219-A1 require identity clearance. Unauthorized voting is blocked.

FIG. 5D illustrates audit review tools. Identity-driven decisions are inspectable. Oversight is supported.

FIG. 5E illustrates secure export of audit records. Data integrity is preserved. Compliance reporting is supported.

1. An adaptive identity governance system comprising:
a trusted execution environment;
an identity confidence state engine maintaining a persistent identity confidence state;
a policy engine defining identity thresholds based on action intent; and
a hardware-locked pre-computational gate preventing generation of influence forecasts as defined in U.S. Publication No. US-2025-0392470-A1 and trust-weighted governance outputs as defined in U.S. Publication No. US-2025-0391219-A1 unless identity confidence thresholds are satisfied.

2. A method for governing influence and trust-weighted decisions comprising: validating identity within a trusted execution environment; maintaining an identity confidence state using adaptive decay and recursive refresh; evaluating action intent; and blocking generation of governance computation unless identity validity is confirmed.

3. A non-transitory computer-readable medium storing instructions that, when executed by one or more processors, cause the processors to perform the method of claim 2.

4. The system of claim 1, wherein recursive refresh uses zero-knowledge proofs.

5. The system of claim 1, wherein behavioral entropy differentiates human and autonomous agents.

6. The system of claim 1, wherein identity confidence decay is context-aware.

7. The system of claim 1, wherein historical identity states exhibit temporal immutability.

8. The system of claim 1, wherein the system is ledger-agnostic.

9. The system of claim 1, wherein governance outputs are auditable.
